(19) United States
(12) Patent Application Publication
(10) Pub. No.: US 2010/0250285 A1
(43) Pub. Date: Sep. 30, 2010

(54) SYSTEM AND METHOD FOR RECRUITING SUBJECTS FOR RESEARCH STUDIES AND CLINICAL TRIALS OVER THE INTERNET

(76) Inventor: ROBERT SHELTON, Coto de Caza, CA (US)

Correspondence Address: SEYFARTH SHAW LLP, WORLD TRADE CENTER EAST, TWO SEAPORT LANE, SUITE 300, BOSTON, MA, 02210-2028, US

(21) Appl. No.: 12/750,036

(22) Filed: Mar. 30, 2010

Related U.S. Application Data
(63) Continuation-in-part of application No. 12/031,987, filed on Feb. 15, 2008.
Application No. 12/031,987 is a continuation of application No. 11/231,561, filed on Sep. 21, 2005, now Pat. No. 7,664,753.
Application No. 11/231,561 is a continuation of application No. 09/025,279, filed on Feb. 18, 1998, now Pat. No. 7,028,049.
(60) Provisional application No. 61/164,716, filed on Mar. 30, 2009.

(51) Int. Cl. G06Q 50/00; G06Q 99/00; G06F 3/048; G06F 17/30

(52) U.S. Cl. 705/3; 705/317; 715/771; 707/706; 707/E17.108; 707/E17.005; 715/764

(57) ABSTRACT

A system and method for managing private records and other confidential information is provided, including a patient interface that allows patients to configure privileges for various parties to access various private records or portions thereof. A database can be accessed via a privacy engine, which respects the configured privileges and allows searching for private records. A plurality of user interfaces is provided to allow records managers, patients, and interested parties to access selected private information. A clinical trials interface allows limited access to a private records database for interested parties to identify germane clinical trials and research studies. A recruitment interface allows conductors of research studies to access private records to locate appropriate research subjects.

### CROSS REFERENCE TO RELATED APPLICATIONS

This application is a Continuation in Part (CIP) of U.S. patent application Ser. No. 12/031,987 filed on Feb. 15, 2008 which is a continuation of U.S. patent application Ser. No. 11/231,561 filed on Sep. 21, 2005 which is a continuation of U.S. patent application Ser. No. 09/025,279 filed on Feb. 17, 1998 which claims benefit of U.S. Provisional Application No. 60/037,869 filed on Feb. 17, 1996 all of which are incorporated by reference herein in their entirety.

This application also claims the benefit of U.S. Provisional Application No. 61/164,716 filed on Mar. 30, 2009, which is incorporated by reference herein in its entirety.

### FIELD OF THE INVENTION

This invention relates to records searching methods, and more particularly to methods for searching and providing limited access to private records.

### BACKGROUND OF THE INVENTION

The need to search records has existed for as long as written language. Historically, records searching was a painstaking process, usually accomplished via an index or catalog of the material to be searched. The advancement of computer networking technologies such as the Internet has revolutionized the field of records management, allowing searchers to easily locate records in vast databases. The advancement of these technologies has been concomitant with a significant increase in both the amount and type of information that can be searched.

Computer networking technologies such as the Internet allow a searcher to locate a wide array of information in many different forms such as, documents, photographs, drawings, audio, and video, to list a few. Modern search methods are typically performed by using Internet search engines such as Google, Yahoo, Bing, and Wikiseek. These search engines operate by methods that are similar to the old fashioned library card catalogs, i.e. they index web content and use proprietary algorithms to search their respective indexes to provide matches to a searchers desired key words.

The Internet is a publicly accessible network, and most records that can be searched via the common Internet search engines are public. Private records are frequently excluded from the indexing systems of the commonly used search engines, and often cannot be searched via the Internet. This presents a problem for searchers that need to search records of a private nature, or records that contain a mixture of public and private information. An example is the ability of a doctor to search for and access patient medical records. Another important example is the ability of clinical researchers to search for, identify and make contact with potentially appropriate subjects for a clinical trial.

Clinical trials are essential to the advancement of medical science and are a priority for academic health centers, pharmaceutical companies and research funding agencies. Their success depends on the recruitment of a sufficient number of eligible subjects in a timely manner. Unfortunately, difficulties in achieving recruitment goals are common, and failure to meet such goals can impede the development and evaluation of new therapies and can increase costs to the health care system.

Poor subject enrollment is frequently mentioned as representing the most pressing challenge facing the clinical trials community, with the failure to recruit subjects commonly listed as being the foremost reason that studies do not meet deadlines. It is estimated that less than 10% of clinical trials are completed on time and that over 70% of trials run over schedule by more than one month, which problems reportedly result in millions of dollars in lost revenues to drug companies. Beyond such financial ramifications, personal and societal problems also arise from such delays, which result in delaying when pharmaceutical firms are able to get more effective treatments into the hands of individuals who require them.

According to a study conducted by Cutting Edge Information, a consulting firm focusing on pharmaceutical research, patient recruitment costs more money and consumes more time than any other aspect of clinical trials. As a result, reducing its associated cost, shortening its duration and improving the overall effectiveness of the manner in which these firms recruit prospective research subjects have long been industry priorities.

Conventionally, recruitment has been conducted through the investigator site and mass media advertising. With the growing popularity of the Internet, over the past decade research sponsors and clinical research organizations have increasingly turned to the Web as an alternative method for attracting patients and/or for filling the gap in recruiting through more traditional means an adequate number of study participants.

Beyond the increased audience, Web-based recruiting of subjects for clinical trials offers a number of advantages to research sponsors. Among these, the audience for Web recruitment is generally more targeted than firms are able to reach with traditional advertising. Patients that come to recruitment websites are often actively seeking information on a particular disease. And as a result, the cost of recruitment decreases and such websites can provide much more detailed information concerning the trial than more traditional media affords. An executive of one Web-based recruiting firm interviewed for the aforementioned Cutting Edge study reported that Web-based recruitment costs were as many as two to ten times less expensive than traditional media.

There today exist a number of public and privately-funded websites that provide comprehensive lists of clinical trials. For example, ClinicalTrials.gov was developed by the National Library of Medicine and is offered as a free service of the U.S. National Institutes of Health (NIH). The website provides a registry of interventional and observational research trials sponsored by the National Institutes of Health, other federal agencies, and private industry. Each entry includes a summary of the trial protocol, including its purpose, recruitment status, and criteria for patient participation. Trial locations and specific contact information are also provided to assist enrollment.

Clinical trials are registered with ClinicalTrials.gov via a Web-based data entry system called the Protocol Registration System, or “PRS”. According to information on the website, ClinicalTrials.gov currently contains more than 41,000 clinical studies, including studies being conducted in all 50 States and in over 140 countries. ClinicalTrials.gov receives over 20 million page views per month and hosts approximately 31,000 visitors daily.

There are also a large number of privately-sponsored websites and related services for locating information concerning ongoing clinical trial activity. These include Acurian, Inc. (Horsham, Pa.), a full-service provider of clinical trial patient recruitment solutions that reportedly maintains a patient panel of over 45 million patients in its recruitment management platform; Essential Group, Inc. (Gurnee, Ill.), a pharmaceutical services company that reportedly conducts over 550 studies in urology, rheumatology, pulmonology and respiratory disease, endocrinology, cardiology, women's health, gastroenterology and neuroscience; Center Watch (Boston, Mass.), a service of The Thomson Corporation; Clinical Connection, Inc. (Miami, Fla.), a study participant recruiter that reports having a database of over 100,000 members actively seeking clinical trials; Drug Study Central (Marchex Inc., Seattle, Wash.), a service that includes alerts to subscribers by email when a new trial has been set up for their specific condition; and EmergingMed (New York, N.Y.), whose service permits cancer patients to create a patient profile that the firm then uses to match with appropriate clinical trials.

Other commercial web sites include HopeLink, which provides a directory of clinical trials that are open for enrollment; Research Across America, which conducts clinical trials and whose website provides general information regarding them; TheHealthExchange, in which prospective subjects create personalized homepages that will automatically display all clinical trials that match the users' interests or needs; TrialPages, a recruitment firm that provides a large database of clinical trial listings that users can search by topic; Veritas Medicine, which provides a comprehensive clinical trials database that allows patients to be matched to clinical trials based on information they submit confidentially through an online questionnaire; and TrialX.com, which matches specific elements of patient information in order to identify potential trials suited to an individual with those characteristics.

Although recruiting participants for clinical trials and medical research studies adds a variety of unique challenges that must be addressed in order to be effective, the fundamental task of matching one person who is seeking certain attributes with another who has those characteristics or something close to them is certainly not limited to healthcare. Several other fields, such as employee recruitment and commercial matchmaking services, involve connecting people. Within these fields, as the Internet has gained in popularity, a variety of disruptive technologies have increased the efficiency of accomplishing such matchmaking.

For many years, employment agencies (sometimes called search firms) have helped match job candidates to specific job criteria required by prospective employers. The traditional method of matching personnel to job specification criteria requires an individual who is trained in job placement skills to manually review documents such as resumes and other qualifications related information against criteria specified by the potential employer. Such manual systems have had several drawbacks, including that they are very slow and do not afford an effective way to sort unqualified candidates from qualified candidates on a large-scale basis. Accordingly, automated systems for selecting personnel based on job criteria evolved in the art.

According to U.S. Pat. No. 5,164,897 to Neil M. Clark, et al., entitled “Automated method for selecting personnel matched to job criteria,” as of approximately 1989, automated systems were able to match personnel based on the use of key word searching. That is, qualifications of various personnel would be stored in a computer database as, for example, in the form of resumes. The searcher would then type in certain key words that relate to the job qualification criteria hoping to match the key words with the job criteria. The '897 patent and a variety of other known systems of the prior art have sought to overcome various limitations of such manual and automated systems using a variety of fast, automated, logically organized, user friendly, Internet-based methods for matching the qualifications of job candidates to particular job related criteria as supplied by potential employers.

As the Internet has grown in popularity, the systems for resume distribution and Web-based employment recruiting have proliferated. Today, Forrester Research estimates annual revenue for the online recruitment market at about $7.1 billion and IDC estimates annual revenue for the eRecruitment market at $12 billion. Well-known services such as Monster.com, founded in 1994 and the leading online global career network servicing hundreds of thousands of employers; Career Builder, the nation's largest online job site with more than 23 million unique visitors and over 1.5 million jobs; Employment Guide, the nation's leading job board for hourly and skilled workers searching for entry level to mid-management positions; Simply Hired, the world's largest search engine for jobs, which indexes more than 3.5 million jobs from thousands of sources including job boards, classifieds and company Web sites; Yahoo Hot Jobs, currently No. 3 in revenue behind CareerBuilder and Monster.com and others provide facilities to register, post resumes and jobs, and search for jobs. These sites offer facilities to tailor personal resumes in looking for job matches, and utilize centralized servers to store personal and job posting data and to perform job and personnel matching through keyword matching and selection algorithms.

Although for a materially different purpose, matchmaking has also become a popular Internet-based service. For literally hundreds of years, matchmakers (more recently called dating services) have attempted to match individuals interested in locating compatible persons for dating, courtship and marriage. With the advent of computers, and the subsequent proliferation of the Internet, such services have become increasingly computerized and ultimately moved to the online world.

For example, U.S. Pat. No. 5,086,394 to Shmuel Shapira, entitled “Introduction system for locating compatible persons,” discloses an introduction system for participating users, in which each user has a memory device that contains personal data defining the user by personal characteristics such as traits and interests. A local control unit receives the respective personal data from a plurality of user memory devices and compares the personal data of each user with the personal data. Pairs who are matched to predetermined standards by the computer are then automatically paged and an introduction is facilitated.

A few years later, U.S. Pat. No. 6,052,122 to Andrew Sutcliffe and Kevin Dunn, entitled “Method and apparatus for matching registered profiles,” discloses a system of matching a first user with at least one other user of the system by comparing the users' respective characteristics against the criteria of other users. According to such '122 patent, the characteristic and criteria data can be obtained via the Internet, and more specifically through a series of web site screens that prompt the users such data. The system then performs the comparison and provides a list of matches, from which a user is provided with the relevant information through which to make contact with the other users for which a match has been found.

Additionally U.S. Pat. No. 6,735,568 to J. Galen Buckwalter et al., entitled “Method and system for identifying people who are likely to have a successful relationship,” teaches approximating the satisfaction that a user of the matching service has in the relationships that the user forms with others and identifying candidates for a relationship with the user based on the approximated satisfaction. The system of the '568 patent makes available a plurality of communication levels at which the parties who are anticipated to be compatible can communicate, each such communication level allowing the parties to exchange information in a different format.

Currently, a number of popular websites such as Match.com, launched in 1995 and which registered over 40 million singles during its first 10 years; eHarmony, which has over 5 million users and employs the teachings of the aforementioned '568 patent; Perfect Match, which has over 12 million members worldwide; Great Expectations, an online dating service that pre-screens and qualifies all new members in person; Yahoo Personals, and a myriad of others assist persons who are interested in being matched with a compatible user to enter their personal and contact information, and through application of a variety of processing algorithms to be matched, to make contact (virtually) and, if there is mutual interest, to arrange to meet in person.

Persons of ordinary skill in the art will realize that while some aspects of the foregoing systems, methods and apparatuses for employment recruiting and matchmaking provide desirable attributes that would represent an enhancement over the present state-of-the-art in clinical trials recruitment, such technologies are grossly insufficient for addressing the unique needs associated with recruiting subjects for clinical trials and research studies. Among other things, the reasons for this are the consequence of a variety of additional complications, some of which pertain to operating within the healthcare field as a general matter, others arising from much more rigorous attendant legal requirements and scrutiny, and still others based on practical considerations. Thus, as Web-based technologies have proliferated in any number of other fields, the ability to search for and exchange confidential data, and deliver data-based services such as matchmaking and recruitment via the Web has been retarded in healthcare generally, and within the field of recruiting prospective subjects for clinical trials and research studies specifically.

One of the major reasons for this pertains to the degree to which the healthcare field is more strictly regulated, including among other things much more rigorous privacy requirements (without limitation including Federal regulations such as promulgated under HIPAA and HITECH); discrete and often contradictory privacy statutes that govern permitted practices in numerous states, which state laws in fact take precedence over the Federal law to the extent they are more restrictive and/or more protective; and any number of local rules, professional requirements and institutional practices with which such recruitment, records transfer and associated activities must comply.

The healthcare area has lagged behind other fields due in significant part to the fact the underlying data is subject to explicit and/or assumed privacy considerations, and in particular where a data seeker's right to initiate queries and/or a data holder's authority to respond to queries, share or transfer data may be subject to legal restrictions, custom, implicit or explicit agreement, or mere courtesy to adhere to the privacy preferences of the records subjects (as hereinafter defined) and/or one or more third parties.

In order to overcome these constraints, optimal use of the technologies for data queries, analyses, application and exchange that have been developed to address data that is not impeded by such constraints, requires much more robust—some have said “policy-aware” —systems. Persons of ordinary skill in the art will appreciate that the objectives of such systems—sometimes referred to in the aggregate as Web 3.0 technologies—must be capable of increasingly automated adherence with various policies, wishes and regulations (in the broadest sense, collectively herein “preferences” or “rules’) governing such data. However, comparatively speaking, these technologies are in their mere infancy, and systems employing them must still be designed and built.

Perhaps in no other industry are these challenges more readily apparent than respecting access rights to personally identifiable medical information. Thus, despite years of attention by a number of prominent companies and hundreds of millions in public and private sector investment dollars, adequately addressing privacy considerations (as hereinafter defined) persists as one of the pacing issues. At the same time, one of the key challenges faced in developing such systems involves affording users with high levels of granularity in their privacy controls without making it overly taxing for them to enter these privacy preferences in the first place.

Additionally, in the instance of recruiting for participants in research studies and clinical trials, a number of practical considerations respecting informed consent, institutional review board (IRB) approvals, and the need for proponents to express highly technical concepts in simple language, introduce additional complications. Compared with other fields in which online recruitment or matchmaking is more prevalent, there is also a much broader array of characteristics that may be of interest to researchers—quite literally involving tens of thousands of discrete concepts including phenotypic presentation, genotypic characteristics, demographics, symptoms, diagnoses, treatments, psychosocial factors and environmental issues—upon which a researcher may assess one candidate as being preferable over another.

Also, there is commonly the need to locate and secure copies of underlying records, often from as many as a dozen or more independent providers and facilities who have previously examined, attended and/or treated such subjects, either as part of the recruitment process or following it, as part of the study protocol. Additionally, whereas the motivation for individuals to participate in job recruitment and matchmaking services fulfills apparent and fundamental needs, the motivation associated with the decision to express interest in taking part in a clinical trial—particularly by healthy volunteers—is likely to be less clear cut.

Thus, in the latter case, such motivations may include the wish to assist others, to help advance new discoveries that are likely to be too late to directly benefit the study participant, and in some cases the promise of relatively modest compensation and/or improved access to health care services and treatments for the duration of the study. Given the narrower market of prospects from which to draw, and the less apparent motivations, in addition to fulfilling all of the foregoing criteria, an optimal system should preferably facilitate the identification and participation of a large number of prospective candidates.

A number of independent research studies have shown that one of the major reasons that prospective subjects do not participate in clinical trials and other medical research is concerns about privacy. As an example, Harris Interactive in conjunction with Dr. Alan Westin have conducted more than a dozen consumer opinion surveys on health privacy between 1993 and 2009 in which a central topic has been to determine under what circumstances consumers would be willing to have their personal health information used in health research. These studies have shown that 58% of consumers do not believe that current law or organizational privacy policies provide adequate privacy protection or data security; and that when asked why they declined to participate in clinical trials, the single most popular response (30%) was “concern their personal information would not be kept private and confidential”.

Thus, while the foregoing prior art examples illustrate a number of different means for employing the Internet as a channel for promoting clinical trials and making it easier for patients to locate information about various studies, these methods of the prior art have heretofore not adequately addressed the privacy concerns that are consistently reflected in such consumer research studies, nor as a corollary thereof, made it possible for researchers to search for and contact patients based on affording ease of access to the patient's underlying confidential medical records.

### SUMMARY OF THE INVENTION

An illustrative embodiment of the invention provides a system and method for locating persons who are likely to have an interest in being considered for participation in clinical research studies, and who would be motivated to embrace privacy preferences that will enable the use and disclosure of their confidential personal information for such purposes. The disclosed system, method and apparatus provide this aspect of such a preferred system.

Another illustrative embodiment provides a system and method for locating, ordering and tracking the delivery of confidential information such as hard-copy as well as electronic records from past encounters involving the records subject as well as physical samples such as blood, saliva, tissue and other bio-samples, and simultaneously assuring compliance with the laws governing privacy as well as the regulations dictating how much a record holder may charge a record seeker wishing to access and/or receive a copy of such records and/or bio-samples. Preferably such system would integrate the privacy preferences of the records subject concerning such information, thereby making actionable these privacy considerations for the purpose of accessing such user's confidential information. The disclosed system, method and apparatus provide this aspect of such a preferred system.

Such a system and method may provide for a properly authenticated researcher, or a person or agency acting on his or her behalf, to identify, compare, and be authorized to contact individuals who are suited to being subjects in clinical trials and research studies, and for simultaneously assuring compliance with the laws governing privacy, as well as the Federal, state and institutional regulations that dictate what information can be reviewed, when and under what circumstances, both in general as well as with respect to recruitment in particular. Preferably such a system integrates the privacy preferences of the records subject to expressly provide the appropriate party(ies) the right to access and review such information, thereby making actionable these privacy considerations involving a records subject's confidential information. The disclosed system, method and apparatus provide this aspect of such a preferred system.

The illustrative embodiments provide a viable way to address the competing needs for brevity and simplicity in how the records subject's privacy preferences are entered into the system, and at the same time for permitting high granularity in such privacy and access controls in order to account for (potentially) extremely detailed individual privacy preferences as well as Federal, state, local, institutional and situational requirements. Preferably such a system integrates these privacy considerations so as to make them readily discoverable and actionable by properly authorized and authenticated persons and/or entities. The disclosed system, method and apparatus also provide this aspect of such a preferred system.

Additionally, such a system and method may permit various opportunities to charge users for value-added steps such as providing an orderly process for records requests and fulfillment, bio-sample orders and approval for sharing such samples, and receiving personal contact details for prospective research subjects with which to advance the recruitment process. Finally, it is preferable that each of the aforementioned aspects of the system and method be extensible to encompass other areas of the practice of health care and the promotion of wellness, and wherein the foregoing ability to match persons with opportunities based on searching relevant information contained in their health records and expressly permitted access through their privacy considerations is a critical step. The disclosed system, method and apparatus provide these aspects of such a preferred system and other features and benefits as more particularly described.

Another illustrative embodiment of the invention provides a system for managing privacy of private records and/or bio-samples. The system includes a database including a list of parties accessing or requesting private records and bio-samples of a subject. The list correlates record seekers with record holders and sample holders. A patient interface displays graphical indicia of the requests and graphical indicia of privacy preferences associated with respective request. The patient interface includes means for a patient to configure the patient privacy preferences.

Another illustrative embodiment of the invention provides a computerized system for managing requests for private records and bio-samples. The system includes a records database including a list of such private records and/or bio-samples, wherein each of the private records and bio-samples is associated with respective privacy preferences. A request database includes a list of requests for at least one of the private records and/or bio-samples. A records agent module receives the requests and selectively grants requests only if they conform with the privacy preferences and privacy laws. In an illustrative embodiment, requests are granted automatically by the records agent, and records are automatically transmitted to the respective requestor or bio-samples orders are automatically transmitted to a bio-repository for it to process in sending a portion or all of such sample (or data drawn from the analysis of such sample) to the respective requestor.

Yet another illustrative embodiment of the invention provides a system for automatically locating and publicizing topical research studies on an interest group portal. The system includes a database including records descriptive of a plurality of research studies and an interface with means for selecting a set of research studies from the database. An integration module is configured to automatically list the set of research studies on said interest group portal.

### BRIEF DESCRIPTION OF THE DRAWINGS

The features and advantages of the present invention will be better understood when reading the following detailed description, taken together with the following drawings in which:

FIG. 1 is a system flow diagram illustrating a system and method for providing access to a private records database according to an illustrative embodiment of the invention;

FIG. 2 is a system flow diagram illustrating a method of establishing privacy and distribution settings for records such as patient records in a private records database according to an illustrative embodiment of the invention;

FIG. 3, comprising sub-parts 3-A and 3-B, is an illustration of a patient interface in a system for managing privacy of private records in accordance with an illustrative embodiment of the invention;

FIG. 4, comprising sub-parts 4-A, 4-B and 4-C, is an illustration of a record-keeper interface in a system for managing private records in accordance with an illustrative embodiment of the invention;

FIG. 5 is system block diagram illustrating a system for identifying research subjects according to an illustrative embodiment of the invention;

FIG. 6 is an illustrative recruiter interface used in a system for identifying research subjects according to an a embodiment of the invention;

FIG. 7 is a diagram illustrating a distributed digital data processing system environment according to an illustrative embodiment of the invention; and

FIG. 8 is a system block diagram depicting interrelationships among the various illustrative embodiments of the present invention.

### DETAILED DESCRIPTION

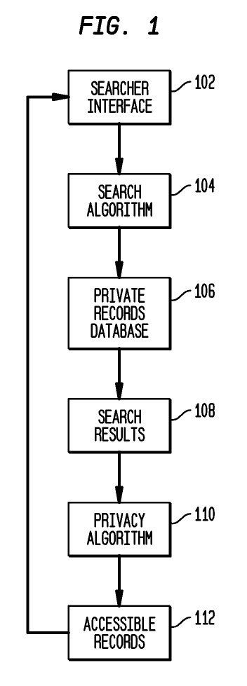

A system and method for providing access to a private records database according to an illustrative embodiment of the invention is described with reference to FIG. 1. Illustratively, a searcher interface 102 allows a searcher to log on to the computer system. During the log on process, the searcher's identity is confirmed and the searcher's access privileges are identified by a user authentication protocol.

Once a searcher's login has been authenticated, the searcher is allowed to search a private records database 106 via a search algorithm 104. The searcher inputs desired search criteria to the search algorithm which communicates with the private records database 106 to recover search results 108 that meet the search criteria. This allows a searcher to search a private database such as a medical records database for a specific patient, primary care physician, or individual or entity that holds a desired medical record, for example. In an illustrative embodiment, the records search result 108 is then processed by a privacy algorithm 110.

The privacy algorithm 110 analyzes the access privileges of the searcher that were defined during the user authentication protocol and correlates those searcher privileges with privacy settings associated with the returned record(s) to determine searcher access. In one illustrative embodiment of the invention, the privacy algorithm can assess a global privilege state of a given medical record, as well as the privilege states of individual sub-records within the global record. Once the ability of the searcher to access the designated record(s) or a redacted portion thereof has been determined, the accessible records 112 results are returned to the searcher interface 102.

In an illustrative embodiment, a searcher can request medical images for a patient whose medical record may have a variety of different medical images, such as dental X-rays, bone X-rays, gastro-intestinal ultrasound images, PET scans, and MRI scans. The patient may have designated certain records, for example, all of the X-rays and ultrasound images, as having a ‘medium’ distribution privilege level, and other records such as the PET and MRI scans as having a ‘high’ distribution privilege level. If the searcher authentication protocol has determined that the searcher has a particular privilege level, then the records within that privilege level can be provided to the searcher. In the illustrative embodiment, certain non-viewable search results are listed in the search result window, but they may display identifying tags that indicate that the searcher does not have privilege to access these particular records. In another embodiment, the searcher will be denied access, and the non-accessible results will not be listed in the search results window. And in yet another embodiment, the patient may be given the option to dynamically consent to (or decline to permit) further access rights in response to a request being made by a researcher whose interest in the patient was initiated based on such researcher's review of the patient's anonymized information.

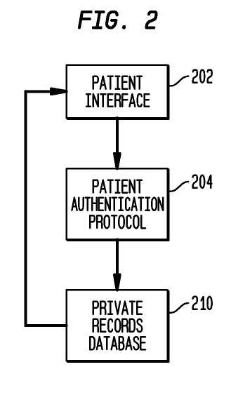

FIG. 2 shows a method of establishing privacy and distribution settings for records such as patient records in a private records database 210 according to an illustrative embodiment of the invention.

According to this embodiment, a patient interface 202 allows a user such as a patient or a patients legal proxy to log on to the system. During the log on process, the patient's identity and access privileges are confirmed by a patient authentication protocol 204. Once the patient's identity and access privileges are confirmed, the patient interfaces with the private records database 210 to modify privacy settings of records to which the patient has authorized access, as determined by the patient authentication protocol 204. This illustrative embodiment allows the patient, or authorized proxy for the patient, to determine what outside persons, agents or entities will be allowed to view the various patient records or particular portions of the patient's records, and for what purposes. Alternatively, such access rights may be based on the existence of certain circumstances, such as the existence of a medical emergency, or other rules or roles, or any combination thereof. In illustrative embodiments, the patient may set distribution settings for electronic medical records and/or for hard copies of medical records or bio-samples that do not exist in electronic form, for example.

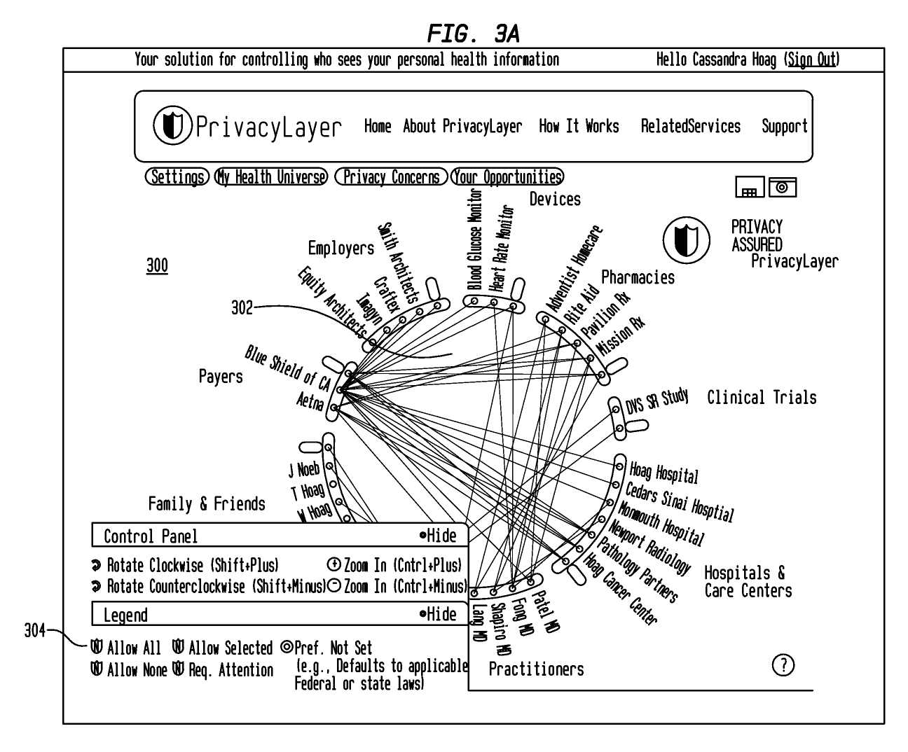

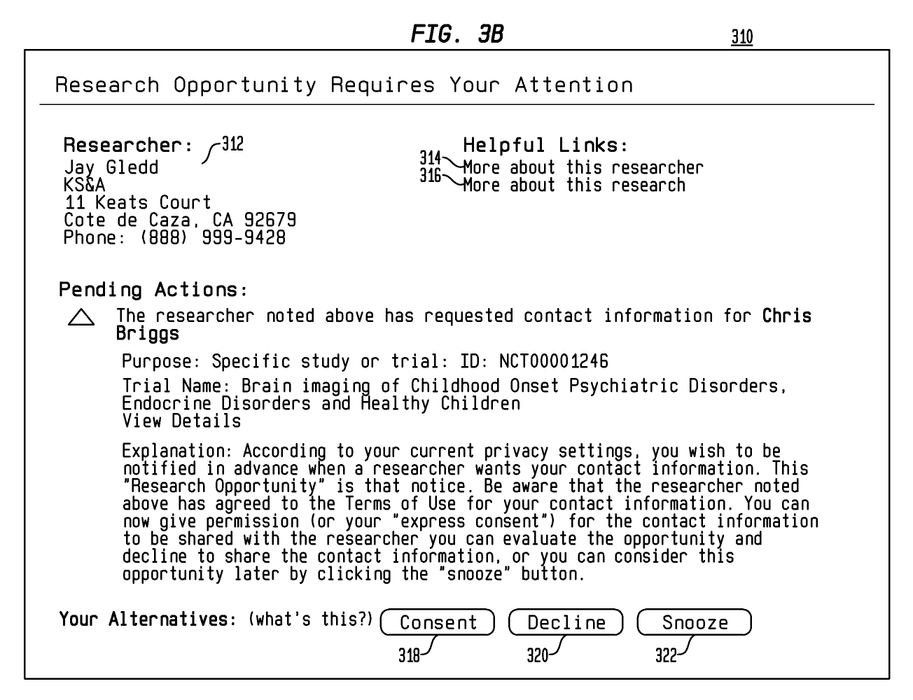

Referring to FIG. 3-A, another illustrative embodiment of the invention provides a system for managing the privacy of confidential records and/or bio-samples. The system includes a database including a list of parties accessing or requesting access to private records of a subject. The list correlates record seekers with record holders, and affords the patient an opportunity to permit access, block access or create rules for situations in between these two extremes. A patient interface 300 displays graphical indicia 302 of the requests and graphical indicia of such privacy preferences 304 associated with respect to each record holder and record requester (or in the instance of redaction, with respect to each specifically redacted portion of a designated document). Patient interface 300 also includes means for a patient to configure these patient privacy preferences using point-and-click technologies and other techniques that are well known to persons of ordinary skill in the art of graphical user design for consumer-oriented user control interfaces.

Referring next to FIG. 3-B, another illustrative embodiment of the invention provides a system for managing the privacy of confidential records and/or bio-samples. A patient interface 310 displays graphical indicia 312 of the source of a specific request by a researcher to access portions of the patient's confidential information. Patient interface 310 would be displayed when, for example, the researcher has reviewed anonymized information concerning the patient and wishes to request additional information such as access to the patient's personal contact information or previously redacted or withheld portions of the record and/or bio-sample, if any. Patient interface 310 includes links 314 and 316 for use by the patient if he or she wishes to learn more about the researcher or the proposed clinical trial or research study that such researcher proposes that the patient consider. Persons of ordinary skill in the art will recognize that other links or the display of other information may be provided as well in order to provide the patient with useful information upon which to base his or her decision to grant or deny such access.

In the event that the patient's privacy settings 304 of FIG. 3-A dictate the need for a researcher to obtain further discretionary approvals as a condition to arranging for access to the additional confidential medical information he or she seeks, the system includes in an illustrative embodiment at the bottom of patient interface 310 means for the patient to consent, decline or be reminded at a later time to make such selection with respect to various requests by parties wishing to access additional parts of their confidential records. Accordingly, patient interface 310 includes consent button 318, decline button 320, and snooze button 322 to, respectively, consent to such additional access being granted to the requesting party, decline such requested access to the confidential information, or postpone making such selection.

In an embodiment, patient interface 310 may also include means for receiving a requesting history of a selected party and reporting to appropriate enforcement authorities any offending access attempts. Such interface may be viewed on a computer, mobile device such as a smart phone device or cellular phone with SMS messaging or the like, or using an interactive voice-response (IVR) system when the user does not have a computer or mobile phone device.

Persons of ordinary skill in the art will recognize that the foregoing system of dynamic and staged consents wherein a researcher is able to review certain portions of the patient's confidential record and then contact them—without knowing their identity—to solicit other pertinent confidential information, has a myriad of uses beyond the illustrative example of supporting medical research and clinical trials recruitment. Without limitation, such other applicable uses include supporting personalized medicine, direct-to-consumer marketing, social networking and the like.

Another illustrative embodiment of the invention provides a computerized system for managing requests for private records. The system includes a records database including a list of private records, wherein each of the private records is associated with respective privacy preferences. A request database includes a list of requests for at least one of the private records. A records agent module receives the requests and selectively grants requests only if they conform to the privacy preferences and applicable privacy laws. In an illustrative embodiment, such requests are granted automatically by the records agent, and the applicable records are automatically transmitted to the respective requestor.

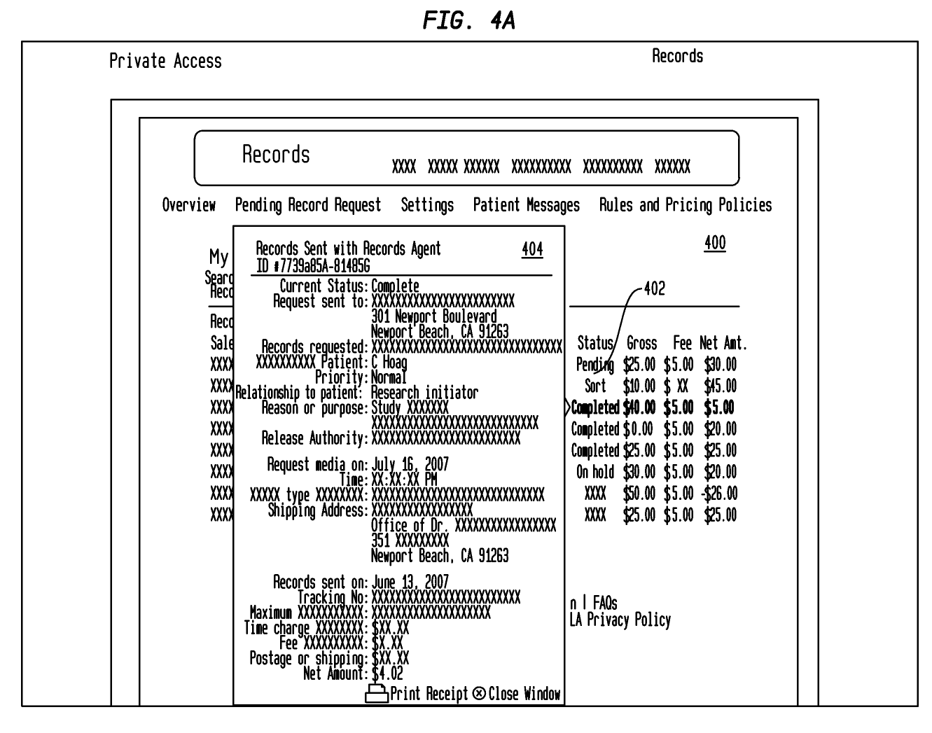

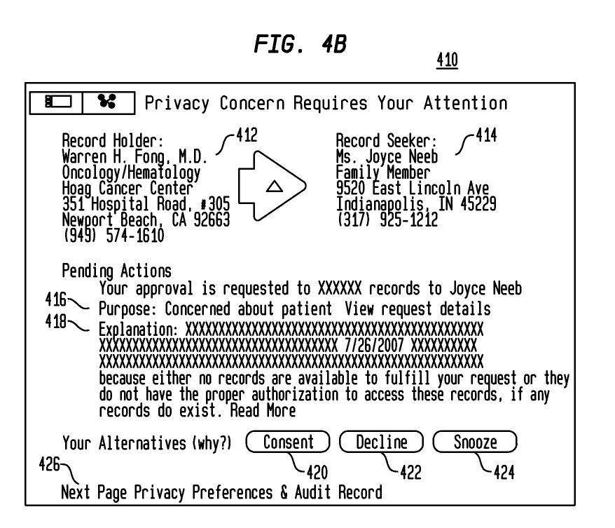

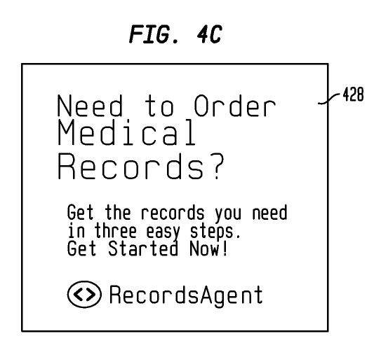

An illustrative record-keeper interface of a records agent according to this illustrative embodiment is shown in FIG. 4-A. The record-keeper interface 400 is configured to display at least a potion of the list of requests for records or bio-samples, the status of ascertaining consent to such sharing of the information, and corresponding status information 402 for the request. The status information can include record transmission status, tracking information, requestor name, requestor address, time of record transmission, transmission cost, and transmission fees, for example. A further detailed report 404 includes other information pertinent to the request, including for example a detailed description of the records sought, payment and shipping information, explanation of the basis for the requester seeking access to the records, and associated tracking details. In an illustrative embodiment, the privacy preferences are configurable by a subject of the private records, physical samples or the like. Referring next to FIG. 4-B, another illustrative embodiment of the invention provides a system for managing the privacy of confidential records and/or bio-samples sought through such system. Patient interface 410 displays graphical indicia for alerting the patient of the identity of the record holder 412, the record requester 414, and the proposed action of transferring certain records to such requesting party. The interface additionally provides an explanation of the basis for the proposed request 416, including a link to view the request details; and an explanation 418 of the basis upon which the consent of the patient is being sought.

As shown in such illustrative embodiment at the bottom of patient interface 410 is means for the patient to consent, decline or be reminded at a later time to make such selection with respect to such request to transfer such record by the record holder. Accordingly, patient interface 410 includes consent button 420, decline button 422, and snooze button 424 to, respectively, consent to such transfer by the record holder to the requesting party, decline such proposed transfer of the document, or postpone making such selection. In an illustrative embodiment, patient interface 410 also includes a means such as link 426 for the patient to amend the privacy preferences respecting this record holder, which in a properly integrated system would revise the settings reflected in user interface 302 of FIG. 3-A; and to view an audit trail for all disclosures made by this record holder or with respect to this record seeker, and report in any inappropriate activity observed in such audit record.

It will also be apparent to persons of ordinary skill in the art that such properly integrated system incorporating the foregoing disclosed attributes would make it possible for record holders such as hospitals and physicians' offices to replace telephone-based personnel for handling records requests and, in their place, provide a link on their Web home page or portal for ordering records. An illustrative example of such a link is shown in FIG. 4-C. Upon clicking such link 428, the requesting party would fill out a form that would in turn populate the data shown in FIG. 4-A, and cause to be issued—to the extent required by the patient's privacy preferences and the applicable law—the dynamic consent request illustrated in FIG. 4-B, whereupon in a fully-automated system such document could be automatically provided to such requester or in a manual system, the office administrator would have all of the information necessary to manually prepare and send such requested document or materials. It will be apparent to persons of ordinary skill in the art that in either instance, presuming that in the latter case the administrator enters details about the date of transmittal and identifying information for the parcel, the disclosed invention will automatically result in independent documentation for the basis upon which all record transfers was made and audit (e.g., accounting for disclosure) information required by federal regulations and other applicable privacy law.

Another illustrative embodiment of the invention provides a system for automatically locating and publicizing topical research studies on an interest group portal. The system includes a database including records descriptive of a plurality of research studies and an interface with means for selecting a set of research studies from the database. An integration module is configured to automatically list the set of research studies on said interest group portal.

In an illustrative embodiment of the system for automatically locating and publicizing topical research studies the means for selecting a set of research studies may include a search engine, which receives a query descriptive of desired research study topics and returns said set of research studies. The system may also include means for customizing a display format of the set of research studies on a portal by the subscriber. In an illustrative embodiment, the system may also include means for automatically updating a subscriber's interest group portal with current research study information from said database and incorporating other complementary features such as a feedback system for other users to rate the information presented and to view the ratings provided by others.

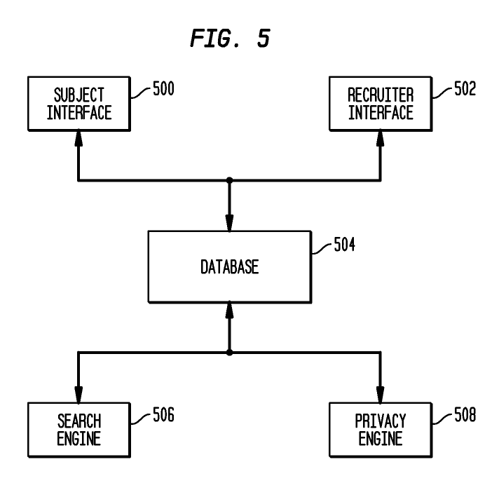

Another illustrative embodiment of the invention described with reference to FIG. 5 provides a system for identifying research subjects. The system includes a database 504 including records associated with potential research subjects. The records include information identifying subject conditions and/or attributes. A subject interface 500 is configured to receive the information and to receive privacy preference settings from the potential research subjects. Subject interface 500 preferably includes educational materials, social networking opportunities with patients that have the same or similar condition, information about related clinical trials and other research studies, and other related content of interest to patients with such condition. A recruiter interface 502 is configured to receive a search query identifying desired conditions and/or attributes of a research subject, and to display search results. A search engine 506 receives such search query and returns, from the database 504, a list of potential research subjects matching the query. A privacy engine 508 is configured with the search engine to restrict the list of search results regarding potential research subjects that is revealed to the researcher in accordance with the privacy settings and applicable law.

In an illustrative embodiment, privacy settings may indicate an interest or disinterest in a particular category of research study, for example. The privacy settings may be configurable by the potential research subjects for each of a plurality of fields in the records. The privacy settings may also be configurable by the potential research subjects to allow selected fields to be viewed only by selected categories of searchers. In the illustrative embodiment, the list may include an anonymous identifier for each potential research subject matching a search query. The list may also include means for contacting a potential research subject by a searcher while maintaining anonymity of said potential research subject.

In cases where the researcher expressing interest in such search results wishes to see additional, more detailed information about the person such as an opportunity to review specific medical records or to analyze bio-samples, the prospective subject can be contacted through an interface such as illustrated in FIG. 4-B and dynamically consent (or decline to consent) to the release of such additional information, whereupon the researcher is informed through the system of such decision, and if permitted by such subject's action, provided the additional information. It will be apparent to persons of ordinary skill in the art that an optimally designed system would make it possible, if the patient so wishes, for the patient's identity to remain undisclosed to the researcher in the event the patient wishes to maintain his or her anonymity, and the system optionally provides for this. Similarly, if the researcher expresses interest in making contact with an anonymous potential subject, the individual can be contacted through an interface such as illustrated in FIG. 3-B, and the patient is provided an opportunity to dynamically consent (or decline to consent) to such contact being made, whereupon the researcher is informed through the system of such decision, and if permitted by such subject's action, provided the patient's contact information.

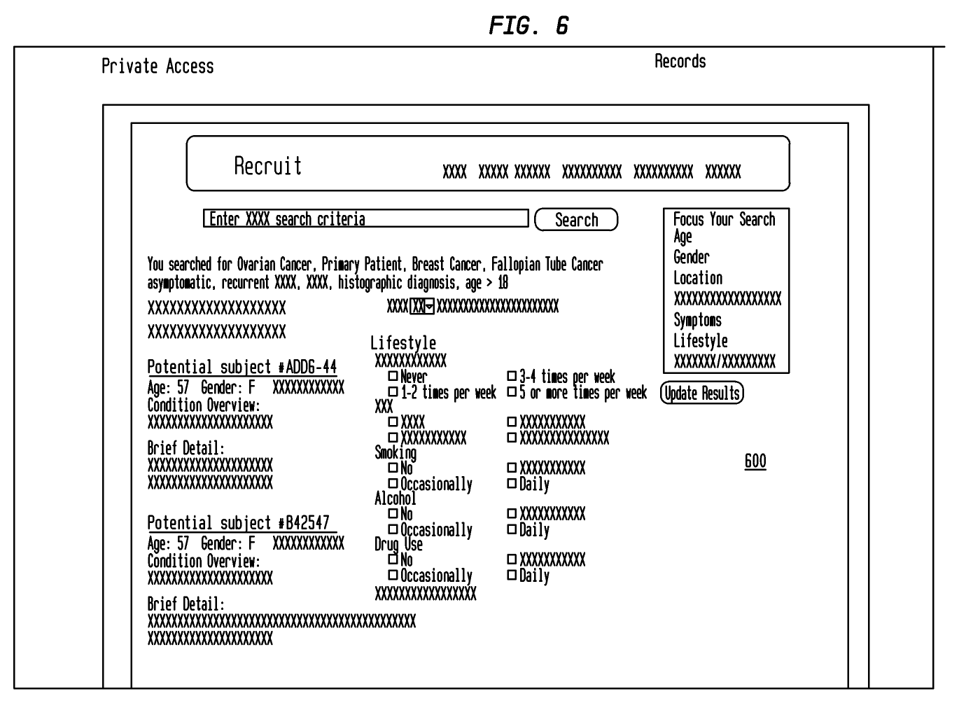

In embodiments of the system for identifying research subjects, the search engine may include a field selector that is configured to narrow a search for potential research subjects according to information in a selected field of the records. Selected fields may include age, gender, location, condition, indications, symptoms and lifestyle of said potential research subjects, for example. FIG. 6 shows an illustrative recruiter interface 600 according to an illustrative embodiment of the invention.

A well-ordered system and method of recruiting subjects for research studies and clinical trials will, without offending the privacy considerations of a records subject, facilitate clinical investigators and research organizations to search pertinent records concerning prospective research subjects to locate the records subjects that best fulfill the research protocol associated with validating hypotheses, confirming therapeutic benefit, and attaining answers to questions raised in such research. Additionally, such system and method will facilitate the clinical investigator and/or research organization contacting that or those records subjects who best fulfill such research protocol (including healthy controls where desired), such contact taking into account the privacy considerations of each such records subject.

As noted in the Background discussion, a number of independent research studies and consumer surveys indicate privacy concerns as having historically been a major reason for subjects not volunteering for clinical trials participation, which concerns are alleviated through the instant system and method. Accordingly, a well-ordered system and method of recruiting subjects for research studies and clinical trials will, without offending the privacy considerations of a records subject, facilitate clinical investigators and research organizations to contact records holders to request access to pertinent information as well as copies of pertinent records respecting the records subject. Thus, in one illustrative embodiment, the system and method disclosed herein will complement systems for identifying and making contact with prospective research subjects by facilitating record seekers to secure electronic and hard-copies of records and/or bio-samples (or relevant data and/or information contained therein) from record holders.

Additionally, a well-ordered system and method of recruiting subjects for research studies and clinical trials will enable and encourage records subjects to establish one or more privacy consideration so as to make the pertinent information available to such clinical investigator(s) and/or research organization(s) for the foregoing purposes of identifying research subjects and making contact where desired, and effectuating the transmittal of records and bio-samples held by record holders to record seekers, where appropriate. Thus, in one illustrative embodiment, the system and method disclosed herein will complement systems for identifying and making contact with prospective research subjects by facilitating records subjects to learn about clinical trials and research investigations that are most likely to be of interest to them, and to establish their privacy considerations in an efficient, economical and reliable manner.

In this regard, in one illustrative embodiment, the system and method disclosed herein will facilitate one or more disease advocacy groups, affinity groups and social networks (as each of these terms are hereinafter defined) to get word out to their members regarding the clinical trials and research studies that pertain to the disease, disorder or condition that affects the members of that group or network, and/or that are most likely to be of interest to such persons. In yet another illustrative embodiment, the system and method disclosed herein will facilitate such groups receiving a share of the consideration paid, if any, to enrolled subjects by the research sponsor.

Although the foregoing embodiments are described in the illustrative embodiment of recruiting subjects for clinical trials and research studies, it will be apparent to those of ordinary skill in the art that various ones of these embodiments are also relevant to addressing other needs of record seekers, record holders and/or records subjects. For example, that portion of the illustrative embodiments focusing on handling records requests and bio-samples, and complying with related privacy considerations may be applicable to the needs of any record seeker wishing to order confidential records from record holders (e.g., irrespective of the possible recruitment of such records subject for a research study or clinical trial). Without limitation, in the case of medical records, representative examples of this include situations where an attending physician wishes to order a copy of prior test results from a laboratory or radiologist, or the records or bio-samples from earlier patient encounters from another physician who has attended the records subject, or from a registry or bio-bank; or where a patient wishes to order copies of records for upload into a personal health record (PHR) system, for use in conjunction with submitting an application in which certain medical information is required.

Similarly, that portion of the one illustrative embodiment focusing on controlling who and under what circumstances others can see otherwise confidential records of a records subject may be applicable to the needs of any record seeker wishing to access some or all portions of the records of a records subject (e.g., irrespective of the possible recruitment of such records subject for a research study or clinical trial). Without limitation, in the case of medical records, representative examples of this include the records subject providing the authorization for any number of record seekers to access certain portions of his or her medical record but protecting other portions of such record from discovery or transfer.

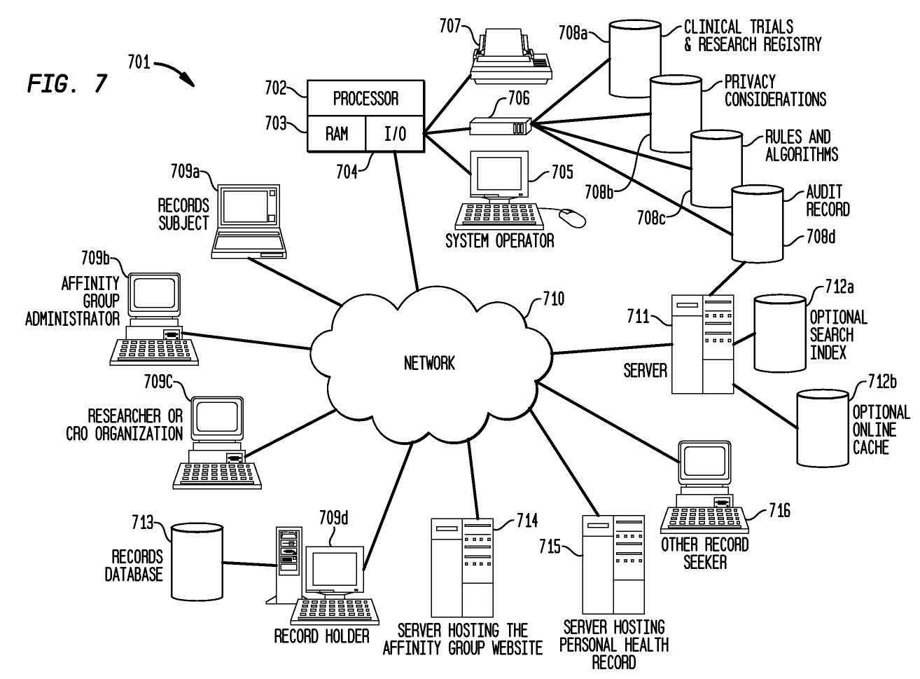

Now turning to FIG. 7, it will be observed that it depicts the primary components of a preferred system in accordance with the principles of the invention. Depicted therein are a digital data processor 701, including a processor section 702, a random access memory section 703, and an input/output control section 704. Digital data processor 701 is connected via input/output control section 704, to workstation 705 (including a monitor, keyboard and pointing device), one or more drives or alternative storage media 706 for storage of software and data, and printer 707. As shown, the software and data maintained on storage media 706 preferably includes a clinical trials and research registry database file 708(a); privacy considerations database file 708(b); rules and algorithms 708(c); and audit record 708(d). FIG. 7 also depicts an optional secure online cache 712(a) and search index 712(b), each connected through server 711.

As depicted, digital data processor 701, as well as its sub-components 702-704, peripherals 705-707, related databases and/or software 708(a), 708(b), 708(c) and 708(d), server 711, and optional secure online cache 712(a) and search index 712(b), comprise the system managed and maintained by the system operator. The system operator's computer, along with other computers 709(a), 709(b), 709(c), 709(d) and 716 may be interconnected via network 710 to file server 711 and have access to web servers 714 and 715. As depicted, computer 709(a) comprises a representative workstation employed by a records subject; and computer 709(b) is illustrative of a representative workstation employed by an affinity group administrator (i.e., a person responsible for content posted on the affinity group's website, hosted on server 714). Although it is considered likely that at least some records subjects will also be affinity group administrators, and therefore may employ a single computer workstation, these functions are nonetheless depicted separately in FIG. 7 for the purposes of illustrating the invention.

Computer 709(c) depicts a representative workstation employed by a research investigator, contract research organization (CRO), or person within a group who is responsible for identifying prospective subjects for ongoing or planned clinical trials and/or research studies. Computer 709(d) illustrates a representative workstation employed by a record holder or other person or entity holding information pertaining to the records subject. Even though in some case, such records holder may be the records subject themselves, either directly or through permitting access to his or her personal health record (PHR), or may be one or more affinity groups to which the records subject belongs, these functions are nevertheless depicted separately in FIG. 7 for the purposes of illustrating the invention. Without limitation, examples of such record holders are medical providers, diagnostic labs, pharmacies and other ancillary care providers, payers, and systems designed to monitor the patient's activity and/or bodily function.

Persons of ordinary skill in the art will recognize that the records pertaining to the records subject may be held in electronic form (e.g., as digital files or portions of electronic databases, etc.) and/or in hard copy form (e.g., as paper records, radiographic images, tape print-outs, and the like), with or without metadata associated therewith. As applicable, FIG. 7 shows records database 713 for storage of such electronic records and/or metadata of the records holder. Persons of ordinary skill in the art will appreciate that such data may be located on a single workstation such as 709(d), within the records database 713 on a local computer, legacy system or data warehouse, and/or be resident on representative server 715 hosting a personal health record for records holders. Examples of this latter form of Web-based records holder systems on behalf of multiple records holders are Microsoft's recently announced HealthVault™, and similar PHR systems sponsored by various insurers, employers and others. Such data may also be located in a central databank repository (or an informatics grid or cloud computing environment) for an integrated practice, enterprise, community, region or country.

As shown, FIG. 7 also depicts a representative “other record seeker” 716 who may be included in yet another illustrative embodiment of the system. Such other record seeker may simply wish to request copies of the records subject's records for treatment, payment or data analysis purposes or the like, or may merely wish to employ portions of such records to establish what offers to make to such records subject, one or more record holder, affinity group administrator, researcher or CRO through the system. Persons of ordinary skill in the art will recognize that such data may be anonymized and/or de-identified by the system prior to making such records available for the foregoing purposes, and then forwarded to the appropriate person or entity by the system operator as part of adherence with various privacy considerations. Additionally, it will be apparent that such other record seekers may incur—and may assess—a fee or charge of some type for one or more of the foregoing services; and that a well-ordered system will permit multiple parties to offer complementary products and services based either on providing (to the extent authorized to do so) additional patient data or data analysis and facilitate such offers through its independent audit function described above and an optional integrated payments system for such products or services to such other network participants in the event these offers(s) are accepted.

Digital data processor 701, as well as its sub-components 702-704 and peripherals 705-707, preferably comprise a conventional commercially available personal computer or workstation adapted in accordance with the teachings below for storing, accessing and processing data bases, rules and algorithms 708(a)-708(d). Computers 709(a)-709(d) and 716; servers 711, 714 and 715; and databases 712(a), 712(b) and 713 also comprise conventional commercially available components of their respective types. Network 710 may be, as a non-limiting example, the Internet or any alternative public and/or proprietary networks. Computers 709(a)-709(d) and 716 can likewise be adapted in accordance with the teachings below for viewing a browser for accessing programs and interacting with the system and other system users according to a system clock and rules database.

As will be perceived by those skilled in the art, pertinent components needed for implementation of the system will vary corresponding to certain optional features, and the components identified in FIG. 7 are set forth for illustrative purposes and are not intended to suggest that all of such components and/or data are required in every instance in order to implement the principles hereof. For example, some of the parties for whom computer workstations and/or network connections are indicated in FIG. 7 will be utilized in various illustrative embodiments, and thus the computers and connections to these additional entities identified in FIG. 7 are set forth of illustrative purposes and are not intended to suggest that all of such workstations and connections are required in every instance in order to implement the principles hereof. Similarly, audit record 708(d) is optional and utilized in certain illustrative embodiments. Thus, although all of the elements of the system shown in FIG. 7 are not necessarily utilized in order to practice the principles of the invention and thus some of them are optional, it is deemed apparent that each of the elements illustrated are attractive and add to the usefulness of the overall system.

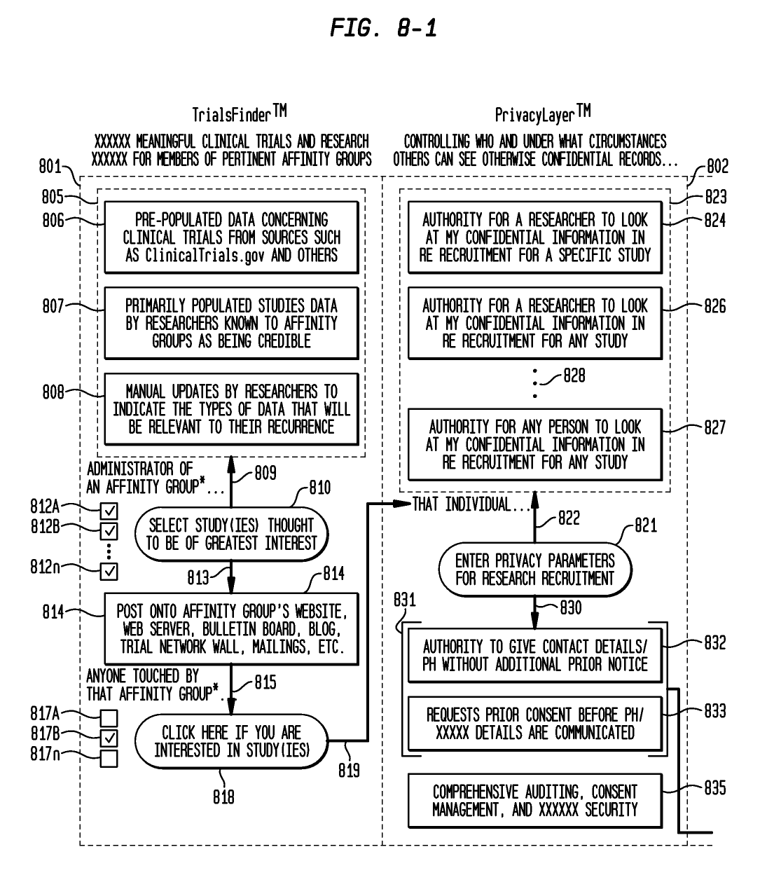

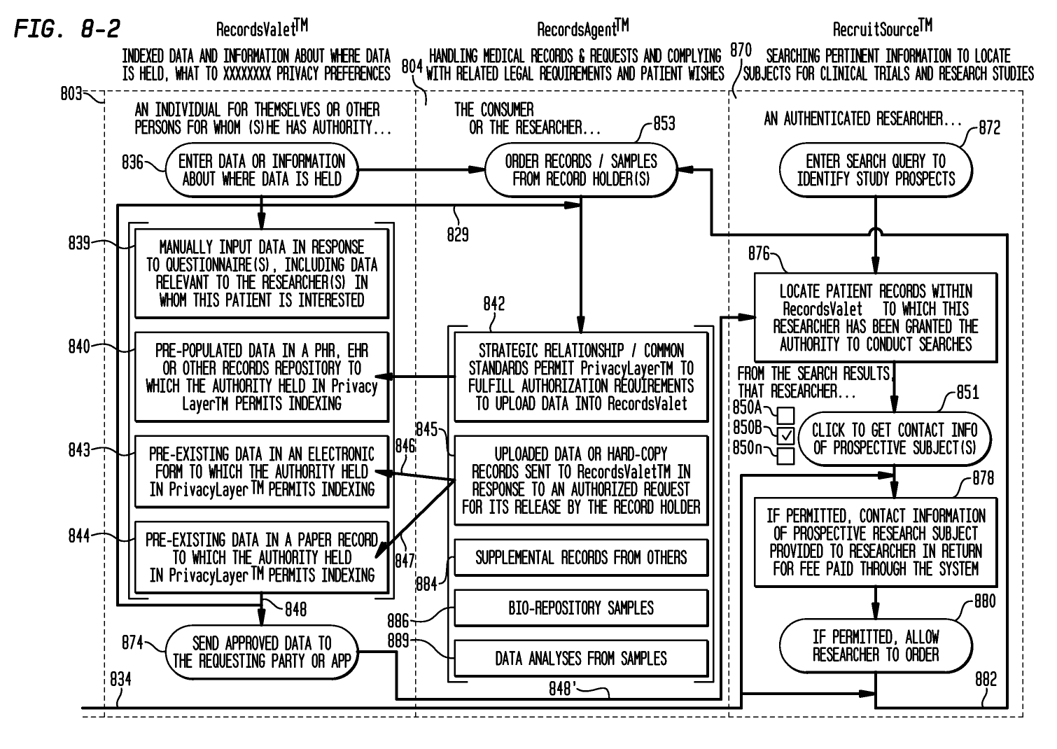

Now turning to FIG. 8, it will be observed that a flow diagram is provided that depicts practice of the principles hereof suitable for implementation in the system identified in FIG. 7. In this regard, it will be observed that FIG. 8 includes five large rectangular boxes 801, 802, 803, 804 and 870, each of which depicts a portion of the operation of the system and method. Although in one embodiment of the system, these five aspects of the system may be designated as separate components as hereinafter described for the purposes of illustrating the invention, such separation, including preferably as individual URLs for each such aspect, is an optional feature.

Persons of ordinary skill in the art will understand that under current privacy regulations, medical researchers are generally required to develop and obtain institutional review board (IRB) approvals for a proposed research protocol before beginning to review confidential records to identify prospective subjects. This requirement introduces additional time and expense that would preferably be avoided. Moreover, under current privacy law, in certain cases, although such health data can be reviewed, this may only be done in a “de-identified manner.” However, de-identified information lacks certain data fields, which renders such information less useful for selecting research subjects. Thus, in a well-ordered system, fulfilling the reasonable privacy considerations of records subjects would be addressed in a manner that does not impose these limitations as an impediment to medical researchers. At the same time, as noted above, it is well documented through a number of research studies and consumer surveys that one of the primary reasons cited by patients against participating in clinical studies is a concern over the privacy of their information. Accordingly, in a well-ordered system, the privacy considerations of individuals would be even more ably addressed than in current systems of the prior art. Under applicable privacy regulations, these objectives can be achieved with the express consent of the prospective research subject for their information to be made available to the applicable researcher for consideration.

Individuals who are suffering from diseases and disorders, who are known to be at heightened risk of such conditions due to genetic or environmental factors, and family members, siblings and other persons who care about them, are more likely to be willing to consent to such use, particularly where reasonable privacy considerations can be accommodated. Accordingly, in a well-ordered system, there would be a way to contact such persons to inform them of clinical trials and research studies that are likely to be of interest to them without being impeded by privacy considerations. In an illustrative embodiment of the system, this goal is achieved by providing a facility for affinity groups in which such persons are members, contributors or readers, to readily locate and publicize the clinical trials and research studies that are most likely to be of interest to such persons. Rectangular box 801 contains those portions of one embodiment of the system for locating meaningful clinical trials and research studies for members of pertinent affinity groups, and refers herein to this function as Trials Finder™

As used herein, the term “affinity groups” includes “disease advocacy groups,” “health-related discussion groups,” and “social networks” (as each of these three terms is hereinafter defined). “Disease advocacy groups” include state, national and international disease advocacy and support organizations, of which there are tens of thousands, many of which operate as non-profit entities, often based principally on the efforts of volunteers. Doctors, physician practices and clinics that specialize in a particular medical condition are also, for the purposes of this disclosure, treated as yet another form of disease advocacy group. Such disease advocacy groups commonly maintain organizational websites and have rosters of members, containing the names, addresses, phone numbers and email contacts for persons affected by the specific condition for which they are organized, as well as family members and other stakeholders such as physicians treating such persons.

A second form of affinity group is health-related discussion groups, including bulletin boards, automated list servers, chat rooms, forums and the like, where persons who are directly or indirectly affected by a particular condition or disorder may communicate synchronously (as in online chat or instant messaging) and/or asynchronously (as in emails and/or threaded posts). By way of a non-limiting example, Yahoo currently has in excess of 140,000 health-related groups, each of which has multiple subscribers; and some of which have hundreds if not thousands of participants. WebMD, Revolution Health and various other popular health-related websites offer similar facilities that serve the function of a virtual support network for such persons to learn about their condition by sharing their experiences. Because such health-related discussion groups tend to be more organic in nature than disease advocacy groups, many do not have the same level of administrative infrastructure. Nevertheless, each has one or multiple points of contact (such as the discussion-group organizer or room “owner”) and all tend to encourage all members to post relevant information for the participants.

A third form of affinity group consists of social networks, including health-related social networking sites such as PatientsLikeMe, Sophia's Garden, Daily Strength, Organized Wisdom and Inspire; more general-purposed social networking sites such as Facebook and LinkedIn; and blog sites such as DiabetesMine, BlogforaCure, and BattlingMS; health-related search engines, wiki's and the like. In each instance, such networks tend to attract loyal readers and contributors that, like health-related discussion groups, provide information and support for persons affected by a particular medical condition, or that share a common interest.

Persons of ordinary skill in the art will appreciate that the foregoing three categories of affinity groups are purely arbitrary and have substantial overlap, but are distinguished solely to assist in describing the invention and may be grouped in any number of different ways without detracting from any of its features. It will also be apparent that although affinity groups are often extremely careful to protect the personal information of its members and participants based on privacy considerations, they are able to use and often do use this information to help carry out the group's mission, which commonly includes helping inform persons who are directly or indirectly affected by a particular disease or condition when opportunities arise that are likely to be of interest. The availability of relevant clinical trials and research studies focusing on the condition or aspects of the typical phenotypic presentation of the condition that affects the group's members may be one such instance. Thus, one aspect of an illustrative embodiment of the invention is to empower such affinity groups to inform their members, contributors and readers about the clinical trials that are available to them and that might help to advance the science, diagnosis, treatment and/or short or long-term prognosis associated with the condition that such persons by definition share in common.

Rectangle 805 of FIG. 8 summarizes the total trials and research studies that would preferably be included in database 708(a) of FIG. 7 of one illustrative embodiment of the system and method. Accordingly, through the system, these studies would be available for review by one or more persons in such affinity groups from representative workstation 709(b) and subsequently for publication by them to the members of such affinity group directly (e.g., by phone, fax, mail and email, etc.) and via posting through server 714. As shown, rectangle 805 is preferably comprised of three sources.

The first, illustrated by rectangular box 806 consists of pre-populated data concerning clinical trials from sources such as ClinicalTrials.gov and other registries discussed in the Background section, above. The second source, illustrated by rectangle 807, consists of studies proposed by researchers known to the affinity group as being credible and that are manually populated into database 708(a) of FIG. 7. Thus, in one preferred system, in addition to 40,000 or more trials that fulfill the criteria required in order to be part of existing registries such as ClinicalTrials.gov, there are anticipated to be an equal or even greater number of studies of which affinity groups are or can become aware. These include smaller pilot studies and investigations, which if successful may lead to further research.

The third aspect of this database, illustrated by rectangle 808, consists of supplemental information about the studies represented by rectangles 806 and 807 but that are not normally contained in traditional clinical trial registries, without limitation including an identification of specific types of information and phenotypic presentation that may be relevant to the recruitment of subjects into such trial. Often, trial sponsors produce promotional materials such as pamphlets, videos and websites that explain in non-technical terms their medical theory underlying the trial and other materials that have been IRB approved for use in promoting interest in the trial by prospective research subjects. Additionally, there are frequently third-party reviews concerning various clinical trials that may be useful to prospective research subjects. Thus, one illustrative embodiment of the proposed system would permit the researcher responsible for these trials and research studies to manually input this desired information into the registry data so that when a prospective subject indicates that they are interested in possibly participating, such answers can be provided or supplemented by reference to such information.

From computer workstation 709(b) of FIG. 7, arrow 809 of FIG. 8 indicates that the administrator or other person with publication rights of an affinity group is able to search the foregoing information represented by rectangular box 805 using Boolean logic and other algorithms that are specially designed to identify those studies that are most likely to be of interest to persons in such affinity group. Based on these search results, as illustrated by oval 810, that person may select from the corpus of all of such trials fulfilling their particular search queries (illustrated by checkboxes 812(a)-812(n) of rectangle 811) the study or studies that they consider will be of the greatest interest to the participants in that affinity group. This selection process is illustrated by the placement of checks in boxes 812(a) and 812(b) from the total list of trials and studies fulfilling the search criteria (such selections corresponding to the contents of rectangular box 814, discussed below).

Arrow 813 illustrates that the system assists such person using computer workstation 709(b) to publicize that selection(s) (e.g., as hereinafter illustrated, of studies 817(a) -817(n) of rectangular box 816) to the members and/or users of the affinity group. Such publication and other notices to said members of the affinity group (including both as published through server 714 of FIG. 7 to the affinity group's web site, list server, bulletin board, blog site, social network wall and the like, as well as through targeted email, letters, phone calls and other forms of contact based on confidential information of the affinity group) is illustrated by rectangular box 814 of FIG. 8.

Arrow 815 represents the review of such information respecting research studies 817(a)-817(n) by any persons touched by that affinity group through their respective computer workstation 709(a) of FIG. 7. In one illustrative embodiment of the system, such publication via server 714 would include a facility such as a button or checkbox capable of being selected from computer workstation 709(a) to permit such person to select from the studies illustrated by rectangle 816 that or those specific trials and/or studies that are of interest to the individual person (who, depending on context, is hereinafter referred to as a records subject, research subject or prospective study participant). This feature of one illustrative embodiment of the system is illustrated by oval 818, and the study or studies selected by such person is illustrated by the check in box 817(b).

Persons of ordinary skill in the art will recognize that, as described in the Background section, various systems are available to correlate certain aspects of patient information such as age, sex, condition or medication, and zip code, with such studies 817(a) -817(n) to produce “matches” as a means to identify to the patient some of the more likely trials for their needs. However, persons of ordinary skill will recognize that such “matching” systems are largely incapable of the precision needed to locate candidates and fall well short of an acceptable solution.

Arrow 819 indicates that once such prospective study participant has indicated an interest in one or more specific research studies and/or clinical trials, in one illustrative embodiment of the system, his or her privacy considerations are ascertained using the workflow illustrated by rectangular box 802. Once these privacy considerations have been ascertained or surmised from selections made (or foregone) by such records subject, a pseudonym for such prospective study participant can be added to the list of prospective study participants available for review and selection by the researcher, CRO or authorized person on their behalf as part of the workflow illustrated by rectangular box 803.

Rectangular box 802 contains those portions of an embodiment of the system and method for controlling who and under what circumstances others can see otherwise confidential records, and refers herein to this function as PrivacyLayer™. In this regard, oval 821 illustrates that in an illustrative embodiment of the system, the prospective study participant will be assisted to enter his or her privacy preferences, including without limitation for illustrative purposes those privacy considerations pertaining to the recruitment process. Thus, arrow 822 illustrates that these privacy consideration selections, which will preferably be made using computer workstation 709(a) of FIG. 7, will occur from a list of alternatives represented by rectangle 823 of FIG. 8. In one illustrative embodiment, these alternative privacy preferences will be prompted based on rules and algorithms 708(c) from database 708(b), and the selections made by such records subject from workstation 709(a) will be recorded in such database 708(b) of privacy considerations applicable to this particular records subject.

Rectangular box 824 indicates one of the more limited alternative privacy preferences, namely that authority is granted by such records subject only for the specific researcher for the clinical trial of interest to that person (e.g., in the foregoing example, illustrated by checkbox 817(b), as noted above) to look at particular confidential information of said records subject exclusively in conjunction with recruitment for that study. Rectangular box 826 illustrates a slightly less conservative but nevertheless still quite limited authority in which rights are granted to a specific researcher to look at the records subject's confidential information in respect to recruitment for any study.

Rectangular box 827 illustrates the other extreme, in which such privacy considerations are more liberally appropriated, and authority is illustrated as having been granted by such records subject for any person (thereby including the specific researcher) to look at all of the records holder's confidential information (thereby including any information deemed relevant by the researcher) with respect to any purpose (thereby including the recruitment process for the indicated study or these particular studies). Ellipses 828 illustrate that between the example of the extremely limited authority conveyed under rectangular box 824, and the effectively unlimited rights expressly conveyed under rectangular box 827, in an illustrative system there can be any number of alternative authority directives that may be selected by the records subject.

Persons of ordinary skill in the art will recognize that there exist a number of other privacy considerations under Federal and state law as well as pursuant to various administrative policies that, depending on the records subject's selections, may govern or otherwise dictate the rights of a research investigator to access certain information regarding the records subject. Although not illustrated in FIG. 8, in one illustrative embodiment of the system, such statutory requirements, administrative rules, institutional policies, and the like, would also be included in the privacy considerations database 708(b) of FIG. 7, and dictated by the rules and algorithms 708(c) where applicable to the confidential information of the records subject.

Arrows 829, 829′ indicates that based on such selected privacy considerations set by the records subject and/or dictated by rules and algorithms 708(c) based on applicable laws and policies, in one embodiment the system automatically dictates what portion and how the records holder's confidential information, may be employed by the system (e.g., the researcher or CRO employing the system) in connection with carrying out the records requisitioning process whose workflow is illustrated in rectangular boxes 803 and 804 and/or recruitment process whose workflow is illustrated in rectangular box 870.

Arrow 830 indicates that another portion of the privacy considerations set in accordance with selections expressly made by the records subject (or in the absence of such selections, by reference to the privacy considerations database 708(b) by the foregoing described process) pertains to the manner in which such research investigator or CRO may be informed of the identity and contact information for the records subject. Two representative alternatives of a preferred system are illustrated in rectangular box 831. These alternatives include, but are not necessarily limited to authority to provide current contact details to such researcher without additional prior notice or consent by the records subject, which is illustrated by rectangular box 832; and conditional authority to give such contact details only upon receipt of prior consent by the records subject, as illustrated by rectangular box 833. Accordingly, in one illustrative embodiment, this latter instance would permit the records subject to remain pseudo-anonymized unless and until a particular research study or other records seeker has confirmed interest based on the pseudo-anonymized information reviewed, at which point the research subject would have the option to expressly consent to such contact information being provided, or to withhold such consent in the event he or she is not interested in taking part in that study.

Arrow 834 indicates that the records subject's privacy considerations illustrated by rectangular box 831 would be used to govern the presentation of the prospective subject among the list of prospective subjects available for review and selection by the research investigator, CRO or authorized person on their behalf as part of the workflow illustrated by rectangular box 803. Thus, in an illustrative embodiment of the system, prospective subjects whose contact information was immediately available upon selection may be designated with one symbol (such as a green indicator), whereas prospective subjects who have reserved the right to consent to such information being provided may be designated by a different symbol (such as a blue or orange indicator) when presented for consideration by the research investigator or CRO via workstation 709(c).

The privacy considerations stated in rectangular box 833 would also be used in an illustrative embodiment of the system to govern whether the records subject's contact information may be immediately viewed upon selection 851, or if the records subject must first consent to such contact information being released to the particular researcher. Persons of ordinary skill in the art will readily understand that the latter setting may be applicable to a records subject that has more broadly authorized release of his or her information (e.g., without taking the time at the outset to indicate each particular study for which he or she wishes to be considered), and thus care to first find out who has expressed interest in recruiting them before having their contact information revealed to that person or entity. Rectangular box 835 illustrates recordation of changes to privacy considerations in a comprehensive audit log. Such records may be used for consent management and related security processes, for example.

Rectangular box 870 illustrates those portions of an illustrative embodiment of the system and method for searching pertinent information to locate subjects for clinical trials and research subjects, and refers herein to this function as RecruitSource™. In this regard, oval 872 illustrates that in an illustrative embodiment of the system and method, a researcher authenticated in accordance with the privacy considerations of the records subject will from computer workstation 709(c) of FIG. 7 be able to enter search queries into the system in an effort to identify study prospects. Such queries will be directed against confidential information of the records subject, more particularly comprised of data illustrated by rectangular box 838.

Rectangular box 803 illustrates portions of an illustrative embodiment that index data and information about where data subject to privacy preferences is held. As represented by oval 836, an individual may enter data or information about where data is held for themselves of for other persons for whom (s)he has authority.

Rectangular box 804 illustrates portions of the illustrative embodiment that handle medical records requesting and complying with related legal requirements and patient wishes. As represented by oval 853, a consumer or the researcher orders records and/or bio-repository samples, for example, from the record/sample holder(s).

As shown, the researcher's authority to conduct such searches of the otherwise confidential information of the records subject is based on the privacy preferences entered by the records subject from his or her computer workstation 709(a), and illustrated by oval 821 of FIG. 8, or the privacy considerations governing such circumstance in the event that one or more such preferences are or were not set by the prospective study participant. The information against which such search queries by the research investigator or CRO organization will be directed in an illustrative embodiment of the system includes manually input data provided by the records subject including, where applicable, in response to specific questions recommended by the researcher, as illustrated by rectangular box 808. This manually input data is illustrated by rectangular box 839, and depending on the preferences of the system operator and records subject may be stored among other places in any of records databases 712 or 713, on server 714 belonging to the affinity group, or on server 715 belonging to a PHR system in which the records subject is an authorized user, respectively illustrated in FIG. 7.

Additionally, the information against which the search queries of oval 872 will be directed in an illustrative embodiment of the system includes pre-populated data regarding the records subject located in one or more PHRs, electronic health record (EHR) systems, and/or other records repositories to which the privacy preferences provide authority. This is illustrated by rectangular box 840, and includes data that may be stored among other places in records database 713 and on server 715, each illustrated in FIG. 7.

Those persons of ordinary skill in the art will readily appreciate that the system's ability to access such EHR systems controlled by third parties will depend, in part, on compatibility, system interoperability and express permissions even to the extent that the records subject has authorized the release of such records. A significant amount of work has been and is continuing to be conducted in this area by the Office of the National Coordinator for Health Information Technology (ONCHIT); and standards that will enable and facilitate such interoperability are being recommended by the Health Information Technology Standards and Practices (HITSP) body there under. Accessing these records is likely to require specific permissions and authorities, which may require strategic relationships and the adoption of mutually agreed interfaces, all of which standards and permissions are illustrated by arrow 841 and rectangular box 842.

In a well-ordered system for recruitment of subjects for clinical trials and research studies, and conduct of such work, it will be readily appreciated that it may be desirable to get copies of more detailed information concerning the records holder that is held in electronic and hard-copy form. This fact is illustrated in rectangular boxes 843 and 844, respectively, reflecting that in one illustrative embodiment of the system, the research investigator or CRO may solicit specific records from record holders 709(d) of FIG. 7. Arrows 846 and 847 illustrate the transmittal (respectively by electronic and physical means such as facsimile transmission and/or hand delivery) of such records to the researcher or CRO organization, as indicated in rectangular box 845. Oval 874 illustrates transmission of approval data to a requesting party or application. As represented by rectangular box 876, the authenticated requesting party or application, can then locate records to which they have been granted authority to conduct searches. From the search results, that authenticated researcher can click (oval 851) to retrieve contact information for prospective subject(s). In an illustrative embodiment, contact information of prospective research subjects may be provided (subject to the received permission data) to the researcher in return for a fee which may be paid through the system, as illustrated by rectangular box 878, for example. As illustrated by oval 880 and arrow 882, the researcher is allowed to order records or samples from the record holder(s) if permitted in accordance with the permission data. In the illustrative embodiment of the invention, researchers are also able to request access to various additional private information and materials such as supplemental records from other parties 884, bio-repository samples 886, data analyses from the samples 888, for example.

Arrows 848 and 848′ indicates that based on his or her review of the foregoing search results and other information, in an illustrative embodiment of the system, the researcher is able to compile and view on computer workstation 709(c) of FIG. 7, a list of prospective research subjects illustrated by rectangular box 849, comprising records subjects corresponding to checkboxes 850(a) -850(n). From these prospective research subjects, in one illustrative embodiment of the system, said researcher would be able to select that or those records subjects, illustrated by the check in checkbox 850(b) and 850(n), whom he or she would like to recruit for the clinical trial or research study. As noted above, according to the privacy considerations stated by each such records subject represented in rectangular box 833, the researcher is able to see for which of said prospects contact information is immediately available upon selection and for which prior consent must first be obtained by the system operator.

Oval 851 indicates selection of such prospective research subjects by the research investigator or CRO. Although not illustrated in FIG. 8, in one illustrative embodiment of the system, a charge would be assessed by the system operator for providing the contact information or access to records or bio-samples associated with said selected person(s). In such case, the system would optionally allocate this revenue among the various other data holders, and if desired, the patient. Arrow 852 illustrates that for any records subjects whose privacy considerations represented by rectangular box 832 indicate that such information is immediately available, the agreed referral fee and other charges would be incurred and the contact information would be immediately provided through workstation 709(c) to said research investigator, CRO or authorized person on their behalf.

Arrow 852 of FIG. 8 also illustrates that for any records subjects whose privacy considerations represented by rectangular box 833 indicate that the prior consent of such records subject is required before the contact information may be communicated to the research investigator, a notice of such selection would be sent via workstation 709(a) or printed on printer 707 and conveyed by facsimile, mail or other stipulated means to the prospective subject. Upon receipt of confirmation that such records subject wishes to take part in such research study or clinical trial, and thereby consents to his or her contact information being provided, that personal information will be communicated to the research investigator or CRO and the corresponding referral fee or service charge, if any, will be earned by the system operator and optionally allocated among other network participants as discussed above.

Finally, rectangular box 804 illustrates those portions of an illustrative embodiment of the system and method for handling records requests and complying with related legal requirements and patient wishes, and refers herein to this function as Records Agent™. In this regard, oval 853 illustrates that in an illustrative embodiment of the system and method, a research investigator or other record seeker authenticated in accordance with the privacy considerations of the records subject will from computer workstation 709(c) and/or 716, respectively, be able to order records from one or more record holders, a representative one of which is at computer workstation 709(d).

As previously discussed, in a well-ordered system, where such records exist in electronic form, they may be uploaded directly to the research investigator or other record holder at computer workstation 709(c) or 716, respectively. Alternatively, in one illustrative embodiment, such orders of electronic records could be uploaded to the secure online cache 712 of the system operator, who would in turn send a notice indicating the availability of such records to be picked up from said cache by the research investigator or other record seeker. On the other hand, where such records are maintained in a hard copy form, the record holder may transmit them to the researcher or record seeker using mail, facsimile or courier delivery. In one illustrative embodiment of the system, tracking information is maintained in audit record 708(d), and the package may be tracked at any time from the applicable computer workstation. Also in an illustrative embodiment of the system, although not illustrated, the system would enable a service charge to be assessed in connection with such records request and fulfillment services.

The herein disclosed system, method and apparatus for recruiting prospective subjects for clinical trials and research studies is very versatile in that it can be tailored to enhance numerous operations of the system. As such, the points of contact of the various steps with others are intended to link the optional sub-routine into the system at one or preferably multiple points.

Although, as mentioned above, all of the features of the system are not required in order to practice the principles of the invention and thus some are optional, it is deemed apparent that each of the features illustrated in the accompanying drawings and the foregoing description are attractive and add to the usefulness of the invention. Likewise, certain steps of an illustrative embodiment which employ automated entry, calculation and/or reporting, may be conducted through manually written documents or semi-automatically though operation of the system processor and communication by modem, wired or wireless networking and the like.

As will be evident to persons who are skilled in the art, a well-ordered system may provide for the foregoing steps at any number of points in its operation. Accordingly, where these process steps are shown in the drawings and accompanying written description at particular points, it should be understood that this is illustrative only and does not suggest that some or all of these steps may not take place at other points during operation of the system. Similarly, although graphical user interfaces are shown that embody some or all of these features described herein, it should be understood that these interfaces are merely illustrative and should not suggest that some or all of these features may not be carried out using one or more different graphical user interfaces.

Additionally, although the disclosure hereof has been stated by way of example of illustrative embodiments, it will be evident that other adaptations and modifications may be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of this disclosure.

What is claimed is:

1. A system for identifying research subjects comprising:
a database including records associated with potential research subjects, wherein said records include information identifying subject conditions and/or attributes;
a subject interface configured to receive said information and to receive privacy preference settings from said potential research subjects;
a recruiter interface configured to receive a search query identifying desired conditions and/or attributes of a research subject;
a search engine receiving said search query and returning a list of potential research subjects matching said query from said database; and
a privacy engine configured with said search engine to restrict said list in accordance with said privacy settings.

2. The system of claim 1, wherein said privacy settings indicate an interest or disinterest in a particular category of research study.

3. The system of claim 1, wherein said privacy settings are configurable by the potential research subjects for each of a plurality of fields in said records.

4. The system of claim 1, wherein said privacy settings are configurable by the potential research subjects to allow selected fields to be viewed only by selected categories of searchers.

5. The system of claim 1, wherein said list comprises an anonymous identifier for each potential research subject matching said search query.

6. The system of claim 5 wherein said list includes means for contacting said potential research subject by a searcher and maintaining anonymity of said potential research subject.

7. The system of claim 1, wherein said search engine includes a field selector configured to narrow a search for potential research subjects according information in a selected field of said records.

8. The system of claim 7 wherein said selected fields are members of the group consisting of age, gender, location, condition, indications, symptoms and lifestyle of said potential research subjects.

9. A system for automatically locating and publicizing topical research studies on an Internet group portal, the system comprising:
a database including records descriptive of a plurality of research studies;
an interface including means for selecting a set of research studies from said database; and
an integration module configured to automatically list said set of research studies on said Internet group portal.

10. The system of claim 9, wherein said means for selecting a set of research studies include a search engine, wherein said search engine receives a query descriptive of desired research study topics and returns said set of research studies.

11. The system of claim 9, including means for customizing a display format of said set of research studies on said portal by said subscriber.

12. The system of claim 9, including means for automatically updating said portal with current research study information from said database.

13. A computerized system for managing requests for private records, comprising:
a records database including a list of private records, wherein each of said private records is associated with respective privacy preferences;
a request database including a list of requests for at least one of said private records; and
a records agent module receiving said requests and selectively granting said requests only if said requests conform with said privacy preferences and privacy laws;

14. The system of claim 13, wherein said granting said request includes automatically transmitting said requested records to a requestor.

15. The system of claim 13, further comprising a records agent user interface configured to display at least a potion of said list of requests and corresponding status information for said request.

16. The system of claim 15, wherein said status information is a member of the set consisting of record transmission status, tracking information, requestor name, requestor address, time of record transmission, transmission cost, and transmission fees.

17. The system of claim 13, wherein said privacy preferences are configurable by a subject of said private records.

18. A system for managing privacy of private records, comprising:
a database including a list of parties accessing or requesting private records of a subject said list correlating record seekers with record holders;
a user interface displaying graphical indicia of said requests and graphical indicia of privacy preferences associated with respective request; and
said user interface including means for a user to configure said user preferences.

19. The system of claim 18, wherein said user interface further comprises means for said user to consent or decline said requests.

20. The system of claim 18, wherein said user interface further comprises means for viewing an explanation of selected records requests.

21. The system of claim 18, wherein said user interface includes means for receiving a requesting history of a selected party.
